(19) United States
(12) Patent Application Publication
(10) Pub. No.: US 2016/0035236 A1
(43) Pub. Date: Feb. 4, 2016

(54) METHOD AND SYSTEM FOR CONTROLLING ABILITY ESTIMATES IN COMPUTER ADAPTIVE TESTING PROVIDING REVIEW AND/OR CHANGE OF TEST ITEM RESPONSES

(71) Applicant: ACT, Inc., Iowa City, IA (US)

(72) Inventors: Zhongmin Cui, Coralville, IA (US); Chunyan Liu, Iowa City, IA (US); Yong He, Iowa City, IA (US); Hanwei Chen, Iowa City, IA (US)

(21) Appl. No.: 14/815,448

(22) Filed: Jul. 31, 2015

Related U.S. Application Data
(60) Provisional application No. 62/031,574, filed on Jul. 31, 2014.

(51) Int. Cl. G09B 7/00

(52) U.S. Cl. CPC G09B 7/00

(57) ABSTRACT

An improved method is provided for maximizing accuracy of ability estimates while permitting a test taker to review and/or change responses in computer adaptive testing. One or more ability-dependent items are selected from a pool of adaptive items, the selected ability-dependent item matching interim ability estimates for an examinee. One or more ability-independent items are selected from a pool of non-adaptive items. The interim ability estimate can be generated after each iteration of responses to ability-dependent and/or ability-independent items. The ability-independent items can be randomly dispersed throughout the computer adaptive test. A prescribed ratio can be maintained between the ability-dependent items and ability-independent items for minimizing overestimation of the examinee's ability scores after reviewing and changing one or more test items in the computer adaptive test. Alternatively, ability-independent items can be selected after an incorrect response to an ability-dependent or ability-independent item at a predefined test item location.

### CROSS-REFERENCE TO RELATED APPLICATIONS

This Application claims priority to Provisional Application U.S. Ser. No. 62/031,574 filed on Jul. 31, 2014, all of which are herein incorporated by reference in their entirety.

### FIELD OF THE DISCLOSURE

The present disclosure relates generally to features associated with computer adaptive testing. More specifically, but not exclusively, the present disclosure relates to maximizing accuracy of ability estimates while permitting a test taker to review and/or change responses in computer adaptive testing.

### BACKGROUND OF THE DISCLOSURE

Testing generally involves administering a series of questions among a group of individuals. Historically, the series of questions, often multiple choice questions, are predetermined and independent of an individual's ability; and the same series of questions are administered to all individuals taking a particular test. Thus, the test items are ability-independent and static.

The advent of computer adaptive testing (CAT) has provided several advantages over static testing. CAT utilizes ability-dependent questions. More particularly, CAT maximizes the precision of the test by tailoring subsequent questions based on an assessment of the examinee's performance to that point in the test. For example, if a test taker correctly answers a difficult question, an algorithm will select and administer an equally or increasingly difficult question. By contrast, if a test taker incorrectly answers a question of intermediate difficulty, the algorithm will select and administer a question of relatively lesser difficulty. The testing results are based not only on the number of correct test items, but also the difficulty of the questions attempted and/or answered. Compared to static tests, CAT advantageously require fewer test items to arrive at equally accurate scores.

Since CAT requires a submitted response for the algorithm to determine the difficulty of a subsequent question, a methodology to permit examinees to review and/or change previously submitted responses has not been well developed. Yet research has shown that the reviewing and/or changing previously submitted responses could result in more accurate ability estimates based on reduced anxiety level and the opportunity to fix mistakes.

The practice of item review in CAT, however, is hindered by the potential danger of strategic cheating. For example, examinees might initially answer all items incorrectly on purpose so that subsequent items are easier than their true ability. Then, knowing the opportunity exists to change answers, the examinee could return to the “easier” questions, correct the responses, and get a perfect or near-perfect score. Even for examinees who do not purposely try to take advantage of the system, excessive random guessing can result in underestimated interim abilities and thus easier items being selected by the typical CAT algorithm. After correcting the responses in review, they could get overestimated ability scores. Therefore, a need exists in the art for a methodology that maintains the accuracy of an examinee's ability estimate while providing opportunities within CAT to fix mistakes. A further need exists in the art to provide a CAT environment without any restrictions on item review and modification. A still further need exists in the art to provide CAT methods and systems that prevent overestimations of an examinee's ability by accounting for manipulation and/or cheating.

A primary object, feature and/or advantage of the present disclosure is to maintain the accuracy of an examinee's ability estimate while providing opportunities within CAT to review and modify responses. The further objects, features or advantages of the present disclosure will become apparent from the specification and claims that follow.

### SUMMARY OF THE DISCLOSURE

According to an aspect of the present disclosure, a method for controlling ability estimates in computer adaptive testing providing review and change of test item responses includes the steps of providing a pool of adaptive test items and creating a pool of non-adaptive test items. A CAT is administered. The administration of the CAT includes selecting and administering one or more items from the pool of adaptive test items. After administering the item from the pool of adaptive test items, an interim ability is estimated. At least one item from the pool of non-adaptive test items is selected and administered subsequent to the items from the pool of adaptive test items. The steps of administering the item from the pool of adaptive test items and estimating interim ability are repeated at least once. Subsequent selections of the one or more items from the pool of adaptive test items are made based on the interim ability estimate.

A pre-defined ratio can be maintained between the selected one or more items from the pool of adaptive test items and the selected at least one item from the pool of non-adaptive test items after each iteration. As an alternative to the pre-defined ratio, a determination is made whether a response to the selected adaptive test item is correct at a predefined test item position. The steps of selecting and administering one or more items from the pool of adaptive test items and estimating interim ability are repeated if the response is correct. The step of selecting and administering at least one item from the pool of non-adaptive test items is performed if the response is incorrect.

According to another aspect of the present disclosure, a system for controlling ability estimates in computer adaptive testing providing review and change of test item responses is provided. The system includes a pool of adaptive test items, a pool of non-adaptive test items, and a CAT. The CAT includes one or more items selected from the pool of adaptive test items, and at least one item selected from the pool of non-adaptive test items administered subsequent to the item(s) from the pool of adaptive test items. A first interim ability estimate is generated subsequent to administration of the item(s) selected from the pool of adaptive test items, and a second interim ability estimate is generated subsequent to administration of the at least one item selected from the pool of non-adaptive test items. At least one subsequent selection from the item(s) from the pool of adaptive test items is based on the first interim ability estimate or the second interim ability estimate.

The system can further include a response correlator configured to determine whether a response to the one or more items selected from the pool of adaptive test items is correct. At least one item selected from the pool of non-adaptive test items is administered if the response is incorrect. Similarly, the response correlator can determine whether a response to the one or more items selected from the pool of adaptive test items is correct at predefined test item positions comprising less than a total number of test items from the pool of adaptive test items. In an alternative embodiment, a prescribed ratio is maintained between the item(s) selected from the pool of adaptive test items and the item(s) selected from the pool of non-adaptive test items. Administration of the non-adaptive test items is generally unknown to an examinee. One or more subsequent interim ability estimates can be taken from responses to the subsequent selection from the one or more items from the pool of adaptive test items that is based on the first interim ability estimate or the second interim ability estimate.

According to yet another aspect of the present disclosure, a method for controlling ability estimates in computer adaptive testing providing review and change of test item responses includes the step of generating a non-adaptive test item pool having a plurality of non-adaptive test items. The method also includes selecting an adaptive test item from an adaptive test item pool having a plurality of adaptive test items. The selected adaptive test item is administered from the pool of adaptive test items. The method includes determining whether a response to the selected adaptive test item is correct. If the response is correct an interim ability estimate is generated and another adaptive test item from the pool of adaptive test items is selected and administered based, at least in part, on the interim ability estimate. If the response is incorrect, one of the plurality of non-adaptive test items is selected and administered from the non-adaptive test item pool.

The method can further include the step of determining whether a response to the selected adaptive test item is correct at a predefined test item position. The predefined test item position is unknown to a test taker. If a test item position is not at the predefined test position, a subsequent interim ability estimate can be generated, and yet another adaptive test item from the pool of adaptive test items can be selected and based, at least in part, on the subsequent interim ability estimate. Further, the adaptive test item can be selected from the adaptive test item pool matching the interim ability estimate based, at least in part, on one or more constraints comprising content balance, and item exposure. A second interim ability estimate can be generated after a second response to the one of the plurality of non-adaptive test items. The second interim ability estimate can be independent of the second response to the one of the plurality of non-adaptive test items.

According to still yet another aspect of the present disclosure, a method for controlling ability estimates from review and change of test item responses in computer adaptive testing includes providing a CAT. One or more ability-dependent items and one or more ability-independent items are selected. The selected ability-independent items are independent of the test taker's ability. A plurality of interim estimates is generated based on responses to the selected one or more ability-dependent items. Subsequent one or more ability-dependent items administered to the test taker are based on one of the plurality of interim estimates.

A prescribed ratio can be maintained between the ability-dependent items and ability-independent items for minimizing overestimation of the test taker's ability scores after reviewing and changing one or more test items in the CAT. In such instances, the ability-independent items can be randomly dispersed throughout the CAT. Alternatively, an ability-independent items can be selected only after an incorrect response is provided to the selected one or more ability-dependent items.

### BRIEF DESCRIPTION OF THE DRAWINGS

Illustrated embodiments of the present disclosure are described in detail below with reference to the attached drawing figures, which are incorporated by reference herein, and where:

FIG. 1 is a block diagram providing an overview of a system for accounting for item response changes in CAT in accordance with an illustrative embodiment;

FIG. 2A is a flowchart of a method for controlling ability estimates in CAT that provides for review and/or changes of test item responses accordance with an illustrative embodiment;

FIG. 2B is a flowchart of a method for controlling ability estimates in CAT that provides for review and/or changes of test item responses accordance with an illustrative embodiment;

FIG. 3 is a block diagram for a CAT that provides for review and/or changes of test item responses in accordance with an illustrative embodiment; and

FIG. 4 is a block diagram of a computer network and system in which the aspects of the present disclosure can be implemented.

### DETAILED DESCRIPTION

The present disclosure provides for various methods, systems and approaches to account for review and changes in CAT to eliminate or otherwise minimize overestimation of an examinee's ability. The potential overestimation associated with reviewing and making changes to test item responses in CAT can be fixed, remedied or otherwise addressed in accordance with the objects, features and advantages of this disclosure. The method and system includes generally embedding one or more non-adaptive test items within the CAT. The non-adaptive test items are independent of user ability. Incorporating non-adaptive test items lessens the extent or influence of the adaptive test items, thereby combating the aforementioned abusive testing strategies. For example, in a fifteen-question test, embedding five non-adaptive questions reduces the percentage (and influence) of adaptive test items by 33%. Further, if an examinee has knowledge that test items are not solely based on their previously submitted responses, he or she might be less likely to purposely provide incorrect responses and/or randomly guess on test items. Thus, the adaptive aspects of the test should provide an optimal estimation of ability, particularly during the first complete pass through the test, such that review and/or change should not sacrifice the effectiveness of the CAT.

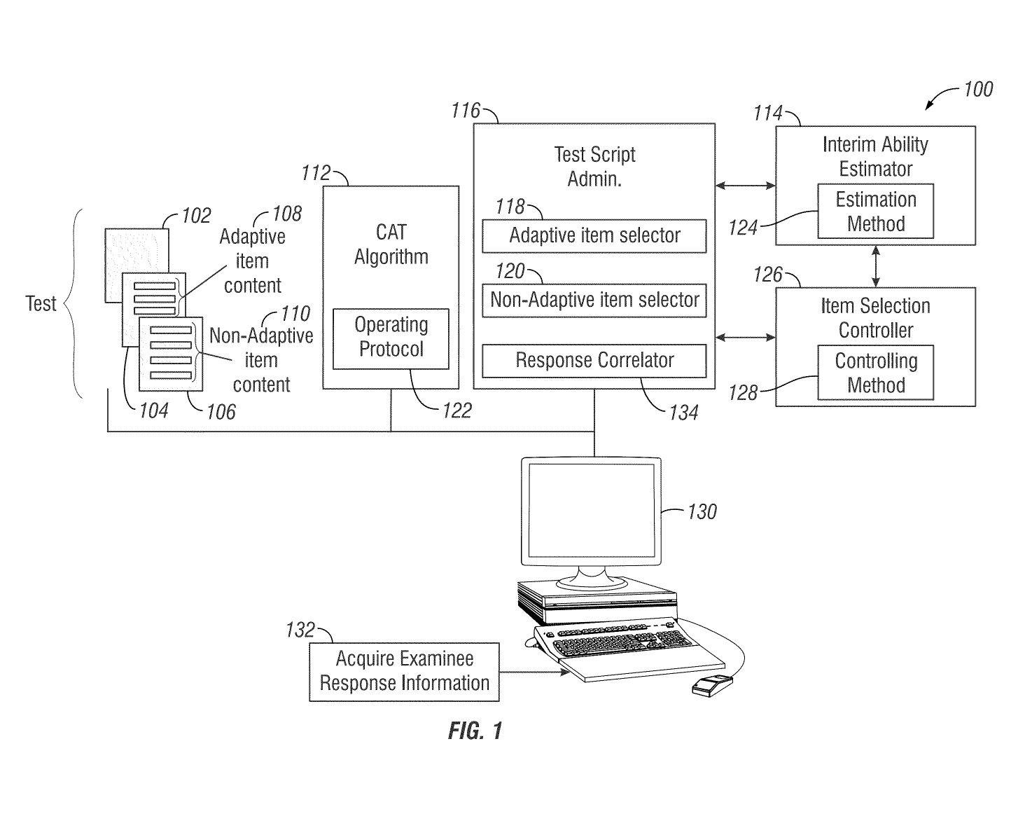

FIG. 1 provides a block diagram for a CAT system 100 for reviewing and changing responses in CAT in accordance with an illustrative embodiment. The system 100 is directed to controlling ability estimates in CAT providing review and change of test item responses. In exemplary embodiments, an ability estimate can include a final score indicative of the examinee's performance on the test, and responses can include an examinee's answer in response to a test item, generally a multiple choice question.

The system 100 includes an adaptive item content pool of adaptive test items. The system 100 includes item content 102, 104 and 106 comprised at least of adaptive item content 108 and non-adaptive item content 110. The adaptive item content 108 can include a pool of adaptive test items having a plurality of adaptive test items. The adaptive test items are configured to be selected by the CAT algorithm 112 based, at least in part, on interim ability estimates as determined by an interim ability estimator 114. The non-adaptive item content 110 can include a pool of non-adaptive test items having a plurality of non-adaptive test items. As mentioned, the non-adaptive test items are independent of an examinee's performance on earlier portions of the test prior to administration of the non-adaptive test item. In an exemplary embodiment, the pool of non-adaptive test items are assembled prior to administration of the CAT.

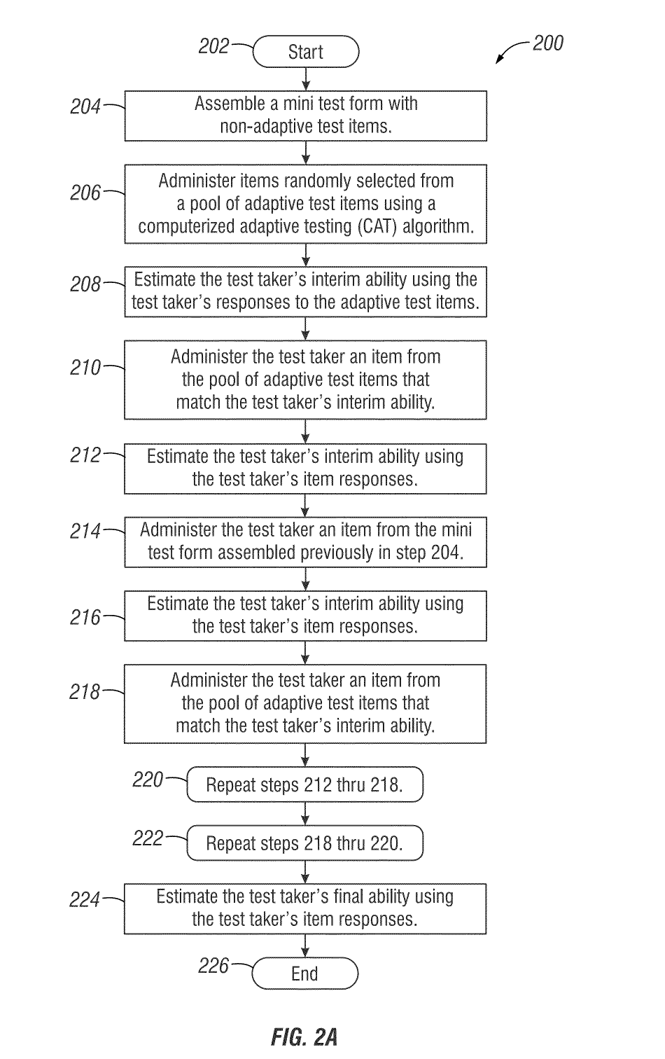

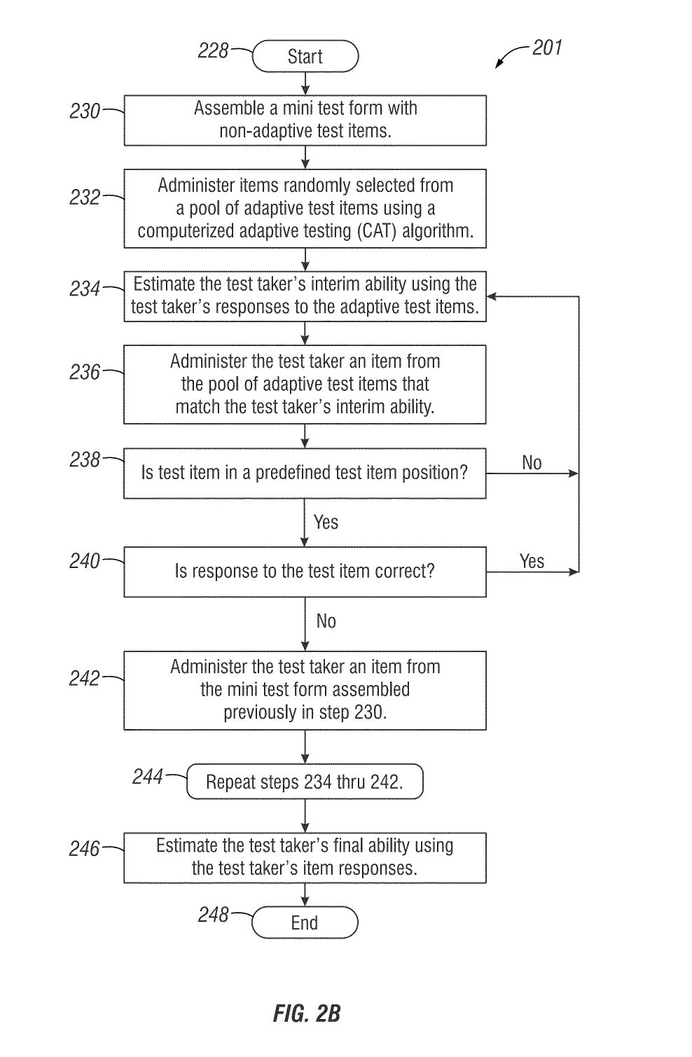

A test script 116 comprises a portion of the CAT. The test script 116 includes an adaptive item selector 118 configured to select one or more adaptive test items from the pool of adaptive test items. The test script 116 can further include a non-adaptive item selector 120 configured to select at least one item from the pool of non-adaptive test items. Upon initiation of the CAT (i.e., the first iteration of the method of FIG. 2), the test script 116 selects item content 102, 104 and 106, so-called opening test items. In a preferred embodiment, the item content 102, 104 and 106 selected during the first iteration of the CAT comprises one, two, or greater adaptive test items randomly selected from the pool of adaptive test items by the adaptive item selector 118. In this limited instance, the adaptive items are not based on an ability estimate, but rather serve to get a baseline for an ability estimate. The greater the number opening test items provides a greater sample size with which to generate an interim ability estimate. In an exemplary embodiment, the opening test items is comprised of five adaptive test items. A computer 130 acquires the responses 132 from the examinee.

Subsequent to the administration the opening test items, an interim ability estimate is determined. The interim ability estimator 114 includes an estimation method 124 commonly known in the art. The results from the interim ability estimator 114 is provided to the CAT algorithm 112. Further, an operating protocol 122 for the CAT algorithm 112 utilizes typical CAT algorithm protocols commonly known in the art.

Based on the output of the CAT algorithm 112, an exemplary embodiment includes an item selection controller 126 that selects either an adaptive test item or a non-adaptive test item. The CAT algorithm 112 and item selection controller 126 can select and administer one or more test items from the pool of adaptive test items. In this instance, the adaptive test item(s) will be based on the interim ability estimate. For example, if the examinee has answered three of the five questions correctly, considered together with their relative difficulty, the CAT algorithm 112 and a controlling method 128 associated with the item selection controller 126 can select a subsequent adaptive test item of intermediate difficulty. For another example, if examinee has answered only one of the five questions correctly, considered together with their relative difficulty, the CAT algorithm 112 and the item selection controller 126 can select a subsequent adaptive test item of lesser difficulty. To this point, attempts from an examinee to invite easier questions through, for example, purposeful incorrect responses, is possible.

However, the CAT algorithm 112 and item selection controller 126 can select and administer at least one test item from the pool of non-adaptive test items. In other words, at least one item from the pool of non-adaptive test items is selected and administered subsequent to the one or more items from the pool of adaptive test items. In this instance, the non-adaptive test item(s) will not be based on the interim ability estimate. Thus, the difficulty of at least a portion of the questions are not influenced by the examinee's performance thus far, thereby reducing the influence of the adaptive nature of the testing and encouraging the opportunity for review and modification of previous responses. Further, the examinee should not be aware that a particular test item is not based on his or her performance on the previous five questions. The incorrect responses, whether purposeful or not, will have lesser influence the relative difficulty of the subsequent questions.

Subsequent to the response to the selected adaptive test item and/or non-adaptive test item, a second interim ability estimate is determined. Again, the estimation method 124 of the interim ability estimator 114 provides results to the CAT algorithm 112 and the operating protocol 122. In an exemplary embodiment, the second interim ability estimate can be based on both the responses to the previously administered adaptive test items and non-adaptive test items. In another exemplary embodiment, the second interim ability estimate can be based on only the responses to the previously administered adaptive test items.

At least one subsequent selection from the one or more items from the pool of adaptive test items by the adaptive item selector 118 is based on the second interim ability estimate and the item selection controller 126 using the controlling method 128. The process continues in an iterative manner: one or more subsequent interim ability estimates taken from response to the at least one subsequent selection from the one or more items from the pool of adaptive test items that is based on previous interim ability estimates.

In the exemplary embodiment, the system 100, and more particularly the operating protocol 122, can be configured to satisfy or otherwise meet a prescribed ratio between the quantity of administered adaptive test items and the quantity of administered non-adaptive test items. The extent of the adaptivity of the test is effectively exchanged for a methodology to maintain accuracy while providing the opportunity for response review and change. In other words, the inclusion of non-adaptive test items slightly diminishes the efficiency of CAT. Yet the present disclosure contemplates striking the appropriate balance between adaptivity and safeguarding. For example, the prescribed ratio between the number of administered adaptive test items and the number of administered non-adaptive test items can be 2:1. That is, if a thirty-item test is administered, twenty test items can be comprised of the adaptive test items and ten test items can be comprised of the non-adaptive test items. While a 2:1 ratio is explicitly disclosed, other prescribed ratios are envisioned without deviating from the objects of the present disclosure.

In the previously discussed exemplary embodiment, the non-adaptive test items within the CAT can be randomly arranged in a manner unknown to the examinee and/or a predefined ratio is maintained. In another exemplary embodiment, however, the at least one selected non-adaptive test item from the pool of non-adaptive test items is administered after an incorrect response to the one or more items selected from the pool of adaptive test items and/or non-adaptive test items. In this arrangement, a predefined ratio between the number of administered adaptive test items and the number of administered non-adaptive test items is preferably not maintained. Instead, the operating protocol 112 is configured to check the responses of test items at predefined test item positions. The predefined test item positions are test items at certain locations in the test. For example, the predefined test item positions can include preselected multiple question numbers (e.g., 1, 8, 12, 20 and 25). The predefined test item positions can be arranged randomly, at intervals, or a combination of the two. The predefined test item positions are preferably unknown to the test taker.

Still referring to FIG. 1, a response correlator 134 is associated with the test script 116. When a response is submitted, the test script 116 determines whether the test item is at a predefined test item position. If the test item is not in a predefined test item position, the CAT algorithm 112, the adaptive item selector 118, and/or item selection controller 126 can select an adaptive test item from the adaptive item content 108 based, at least in part, on the current interim ability estimate. For example, if the test script 116 is configured to generate an interim ability estimate every five test items, and the test taker is on test item two of five, the remaining three adaptive test items can be administered (unless one of the three remaining test items is at a predefined test item position). In another exemplary embodiment, if the test item is not in a predefined test item position, the estimation method 124 of the interim ability estimator 114 provides results to the CAT algorithm 112 and the operating protocol 122. The CAT algorithm 112, the adaptive item selector 118, and/or item selection controller 126 selects an adaptive test item from the adaptive item content 108 based, at least in part, on the updated interim ability estimate. For example, if the test script 116 is configured to generate an interim ability estimate every five test items, and the test taker completes test item five of five (and test item number five is not in a predefined test item position), the test script 116 can generate an interim ability estimate and select an adaptive test item based, at least in part, on the interim ability estimate, as previously discussed herein. In short, if a test item is not in a predetermined test item position, the test script 116 iteratively administers adaptive test items and/or estimates interim ability consistent with the objects the present disclosure previously discussed herein.

If, however, test script 116 determines the test item is at a predefined test item position, the response correlator 134 determines whether the response is correct or incorrect. If the response is correct, an interim ability estimate is generated, as previously discussed herein, and the adaptive test item is selected and administered based, at least in part, on the interim ability estimate. Specifically, the estimation method 124 of the interim ability estimator 114 provides results to the CAT algorithm 112 and the operating protocol 122. The CAT algorithm 112, the adaptive item selector 118, and/or item selection controller 126 select an adaptive test item from the adaptive item content 108 based, at least in part, on the updated interim ability estimate.

If the response is incorrect, the non-adaptive item selector 120 and item selection controller 126 selects and administers and non-adaptive test item from the pool of non-adaptive test items. Following administration of the non-adaptive test item, a subsequent updated interim ability estimate is generated and the adaptive item selector 118, and/or item selection controller 126 selects an adaptive test item from the adaptive item content 108 based, at least in part, on the subsequent updated interim ability estimate. The present disclosure contemplates that the test item position following administration of the non-adaptive test item can also be a predefined test position such that a test taker could encounter two consecutive non-adaptive test items (if both test items at the predefined test item positions are answered incorrectly). Based on the number of predefined test positions relative to the overall number of test items administered, such a scenario is likely to be rare.

As mentioned, in the exemplary embodiment utilizing correctness of responses as a basis of administering non-adaptive test items, a predefined ratio between the number of administered adaptive test items and the number of administered non-adaptive test items may not be maintained. Based on an examinee's responses to the test items at the predefined test item positions, the examinee could encounter less non-adaptive test items than the number of predefined test item positions. In fact, if the examinee's responses to all of the test items at the predefined test item positions are correct, the examinee could encounter zero non-adaptive test items. Such an exemplary embodiment advantageously results in more adaptive test items being administered to examinees who take the test “normally” and/or provide more correct responses, whereas examinees who purposely provide incorrect responses and/or guess randomly will face additional items of predetermined difficulty (i.e., independent of their ability estimate). The embodiment strikes an improved balance between test adaptivity and maintaining accuracy while providing the opportunity for response review and change.

The number of non-adaptive test items can also be a function of the total number of predefined test item positions. Generally speaking, a greater number of predefined test item positions will likely result in an increased number of non-adaptive test items being administered to at least a portion of the examinees. The number of predefined test item positions can be set by a variety of means. In an exemplary embodiment, the number of predefined test item positions is set at an initial ratio such that, at maximum, an examinee could face a 2:1 ratio between the number of administered adaptive test items and the number of administered non-adaptive test items. However, it is emphasized that while the initial number of predefined test item positions could result in the 2:1 ratio, this does not mean an examinee will encounter the same. Yet setting the number of predefined test item positions in such a manner can achieve the same effect as the exemplary embodiment utilizing a fixed predetermined ratio, if, for example, an examinee chooses to excessively guess and/or purposefully answers incorrect with intentions of correcting the same on review. An examinee providing diligent responses (and, presumably getting at least a portion of the test items at the predefined test item positions correctly) is afforded a larger proportion of adaptive test items.

The present disclosure contemplates additional methods for setting the number of predefined item positions without deviating from the objects of the present disclosure (e.g., based off past statistics, selecting the number of predefined test item positions in a manner that, for the majority of test takers, the ratio between the number of administered adaptive test items and the number of administered non-adaptive test items will be 2:1).

Referring to FIG. 2A, an exemplary method 200 for controlling ability estimates in CAT providing review and change of test item responses is provided. The method 200 illustrated by the flowchart in FIG. 2A can be implemented for tests of varying item content count (e.g., thirty-item, forty-item, fifty-item, etc.).

The method 200 can include a start (step 202), such as a start to a CAT. A pool of non-adaptive test items is created (step 204). In an exemplary embodiment, the pool is comprised of a mini-test form compiled prior to operation of the CAT algorithm. The mini-test form can be compiled in the same way a paper-and-pencil test form is constructed. The mini-test form can include any quantity of non-adaptive test items. In an exemplary embodiment, the mini-test includes more non-adaptive test items than will be used in the CAT. In such an embodiment, the CAT algorithm can select the appropriate number of non-adaptive test items so as to maintain a prescribed ratio of non-adaptive test items to adaptive test items. In another exemplary embodiment, the mini-test form includes the exact number of non-adaptive test items that will be used in the CAT. For example, if the test contains sixty test items, and the prescribed ratio is 2:1, the mini-test form will contain twenty non-adaptive test items; the remaining forty test items will be comprised of adaptive test items. In embodiments having prescribed ratios, the non-adaptive test items are dispersed throughout the test in a way unknown to the examinee, preferably in a random manner.

The CAT algorithm selects and administers one or more opening test items during a first iteration of the algorithm (step 206). In the illustrated embodiment of FIG. 2A, the opening test item(s) are adaptive test items randomly selected from the pool of adaptive test items. The quantity of opening test items can be based on a desired sample size in order to appropriately estimate interim ability. For example, in a thirty-item test, the opening test items can include five items randomly selected from the pool of adaptive test items in a similar or typical manner used by CAT algorithms.

After selecting and administering one or more adaptive test items from the pool of adaptive test items (whether or not the items were the opening test items), an estimate is made of the examinee's interim ability using the examinee's responses (step 208). Based on the interim ability estimate, one or more adaptive test items from the pool of adaptive test items can be selected and administered by the CAT algorithm (step 210). In selecting and administering the adaptive test item, other constraints (in addition to matching the interim ability estimate) can be satisfied, including but not limited to, content balance, item exposure, and so forth. A subsequent interim ability estimate (step 212) can be computed using the responses to this point in the method 200.

At step 214, at least one non-adaptive test item can be selected and administered from the mini-test form. Another subsequent interim ability estimate is determined (step 216), and another one or more adaptive test items from the pool of adaptive test items can be selected and administered by the CAT algorithm (step 218). The test repeats in an iterative manner as illustrated in FIG. 2A (steps 220 and 222).

In an exemplary embodiment, the quantity of non-adaptive test items selected and administered can be based, at least in part, on maintaining a prescribed ratio to the quantity of adaptive test items selected and administered. Further, the number of iterations of steps 220 and/or 222 can be modified to maintain the prescribed ratio. For example, in a case where a thirty-item test is being administered, step 220 is repeated one time whereas step 222 is repeated five times to generally maintain or satisfy a prescribed ratio such as a 2:1 ratio.

A final ability estimate is determined (step 224) and the method ends (step 226). Because items from the mini-test form do not depend on the examinee's abilities, the method 200 provides for CAT testing while allowing examinees with unrestricted opportunities to review and make answer changes to any test item at any time before submitting the whole test for a final ability estimate. The method minimizes or otherwise prevents overestimated ability scores from resulting from review and changing of item responses in CAT. Although the procedure, ratio and methods can vary for administering adaptive and non-adaptive test items in combination with taking interim estimates, interim estimates may be only necessary before administering an adaptive item. Similarly, the interim ability estimates are preferably based to both adaptive test items and non-adaptive test items, but the present disclosure contemplates that an interim ability estimate may be based only on responses to adaptive test items.

FIG. 2B illustrates another exemplary method 201 for controlling ability estimates in CAT providing review and change of test item responses is provided. The method 201 illustrated by the flowchart in FIG. 2B can be implemented for tests of varying item content count (e.g., thirty-item, forty-item, fifty-item, etc.).

A portion of the method 201 illustrated in FIG. 2B is the same as that of FIG. 2A. The method 201 can include a start (step 228). A pool of non-adaptive test items is created 230, wherein the pool can be comprised of a mini-test form compiled prior to operation of the CAT algorithm. In the exemplary embodiment of FIG. 2B, the mini-test preferably includes more non-adaptive test items than will be used in the CAT, as the number of non-adaptive test items is based on the responses of the examinee to particular test items.

The CAT algorithm selects and administers one or more opening test items during a first iteration of the algorithm (step 232). In the illustrated embodiment of FIG. 2B, the opening test item(s) are adaptive test items randomly selected from the pool of adaptive test items and of sufficient sample size to obtain an accurate estimate interim ability.

After selecting and administering one or more adaptive test items from the pool of adaptive test items (whether or not the items were the opening test items), an estimate is made of the examinee's interim ability using the examinee's responses (step 234). Based on the interim ability estimate, one or more adaptive test items from the pool of adaptive test items can be selected and administered by the CAT algorithm (step 236). In selecting and administering the adaptive test item, other constraints (in addition to matching the interim ability estimate) can be satisfied, including but not limited to, content balance, item exposure, and so forth.

The exemplary embodiment of FIG. 2B includes determining whether the test item is a predefined test item position (step 238). If the test item is not a predefined test item position, the method 201 can return to step 234 and estimate interim ability using examinee responses to the adaptive and/or non-adaptive test items to that point. A subsequent one or more adaptive test items from the pool of adaptive test items can be selected and administered, based, at least in part, in the updated interim ability estimate (step 236). The present disclosure contemplates that instead of returning to step 234, an additional selected adaptive test item can be administered. Such an instance could occur if, for example, the CAT algorithm is configured to estimate interim ability every five test items, and the instant test item is not yet test item number five.

If the test item is a predefined test item position, the correctness of the response is determined (step 240). If the response is correct, the method 201 can return to step 234 estimate interim ability using examinee responses to the adaptive and/or non-adaptive test items to that point. Steps 236, 238 and 240 can be repeated. If the response is incorrect, a non-adaptive test item from the mini-test form is administered (step 242).

Following administration of the non-adaptive test item, steps 234 through 242 are repeated (step 244). Specifically, a subsequent updated interim ability estimate is generated (step 234); an adaptive test item is selected and administered based, at least in part, on the subsequent updated interim ability estimate (step 236); a determination is made whether the test item is in a predefined test item position (step 238); and a determination is made whether the response to the test item is correct (step 240).

The number of iterations of step 244, namely the number of times steps 234 through 242 are repeated depends on the total quantity of test items in the CAT administration, the number of predefined test item positions, and/or the number of incorrect and correct responses to the test items at the predefined test item positions. For example, if an examinee responds to all test items correctly, steps 242 and 244 may never occur, and thus the method 201 performs an estimate of final ability using the responses to the total quantity of test items (step 246). The present disclosure contemplates that step 246 can occur either not at all or any number of times.

After the final ability estimate is determined (step 246), the method ends (step 248). Since the exemplary embodiment utilizes correctness of responses as a basis of administering a non-adaptive test item, a predefined ratio between the number of administered adaptive test items and the number of administered non-adaptive test items may not be maintained. Rather, based on an examinee's responses to the test items at the predefined test item positions, the examinee could encounter less non-adaptive test items than the number of predefined test item positions. As mentioned, the exemplary embodiment advantageously results in more adaptive items being administered to examinees who take the test normally and/or answer more questions correctly.

Further, in the illustrated embodiment of FIG. 2B, the step of determining correctness of a test item occurs after the responses are provided to the adaptive test items (not opening test items). The present disclosure contemplates that the step of determining the correctness of a response (step 240) can be associated with the opening test items, the first, second or greater iteration of adaptive test items, and/or the non-adaptive test items.

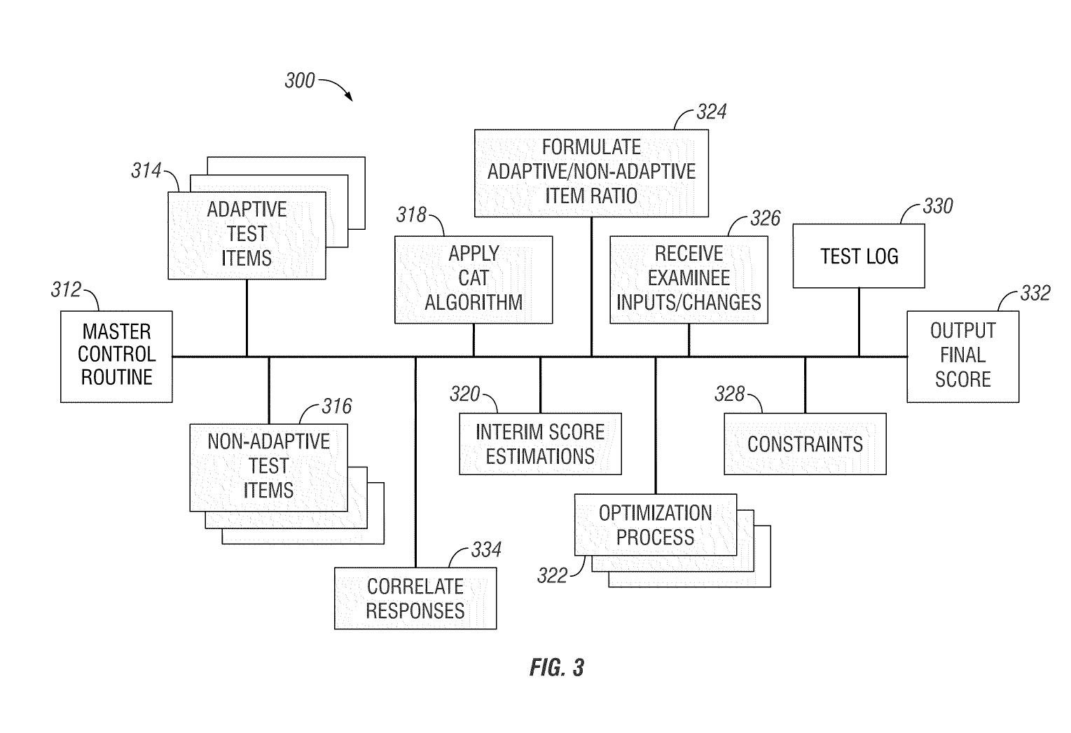

FIG. 3 is another flowchart for CAT item response review and changes in accordance with an illustrative embodiment. The system 300 includes a master control routine 312 for providing an output such as a final score 332. The master control routine 312 applies a CAT algorithm 318 for administering adaptive tests 314 to an examinee. The master control routine 312 selects non-adaptive tests 316 prior to applying CAT algorithm 318. Interim score estimations 320 are calculated subsequent administration of adaptive tests 314 and non-adaptive tests 316. An item ratio is formulated between adaptive and non-adaptive test items 324. According to at least one aspect, the master control routine 312 is configured to satisfy or otherwise comply with a prescribed ratio, such as 2:1 or greater ratio between the number of items in the adaptive tests 314 and the number of items in the non-adaptive test 316. Thus, the number of test items for a test may vary but the ratio between the adaptive test items 314 and non-adaptive test item 316 can still be controlled to maintain the prescribed ratio. In another exemplary embodiment, responses are correlated 334 to determine whether the response is correct or incorrect. Subsequent test items can be based on the response correlation, as discussed above. The response correlation can be in lieu of maintaining a prescribed ratio.

The interim score estimations 320 for adaptive test items 314 and non-adaptive test items 316 are based upon receipt of examinee inputs and changes to the response items 326. An optimization process 322 as previously described can be used when selecting adaptive test items 314 that best match an examinee's interim ability estimate. For example, the optimization process 322 can consider other constraints to satisfy including, for example, content balance, item exposure, and the like, when matching a test taker's interim ability and selection of an adaptive test item 314. Constraints 328 can be applied by the master control routine 312. For example, a constraint 328 wherein a non-adaptive test item list 316 is compiled prior to applying CAT algorithm 318 can be configured as part of the system 300. A test log 330 can be configured as part of the system 300 for observing the test taker's interim ability as both adaptive test items 314 and non-adaptive test items 316 are administered. A final ability estimate provided as an output score 332 as provided at the conclusion of operation of the master control routine 312. The master control routine 312 can be used to repeat any one of the operations of the system 300 so as to, for example, satisfy a prescribed ratio between the number of adaptive test items 314 and non-adaptive test items 316 being administered to the examinee, or to determine predefined test item positions and/or item correctness.

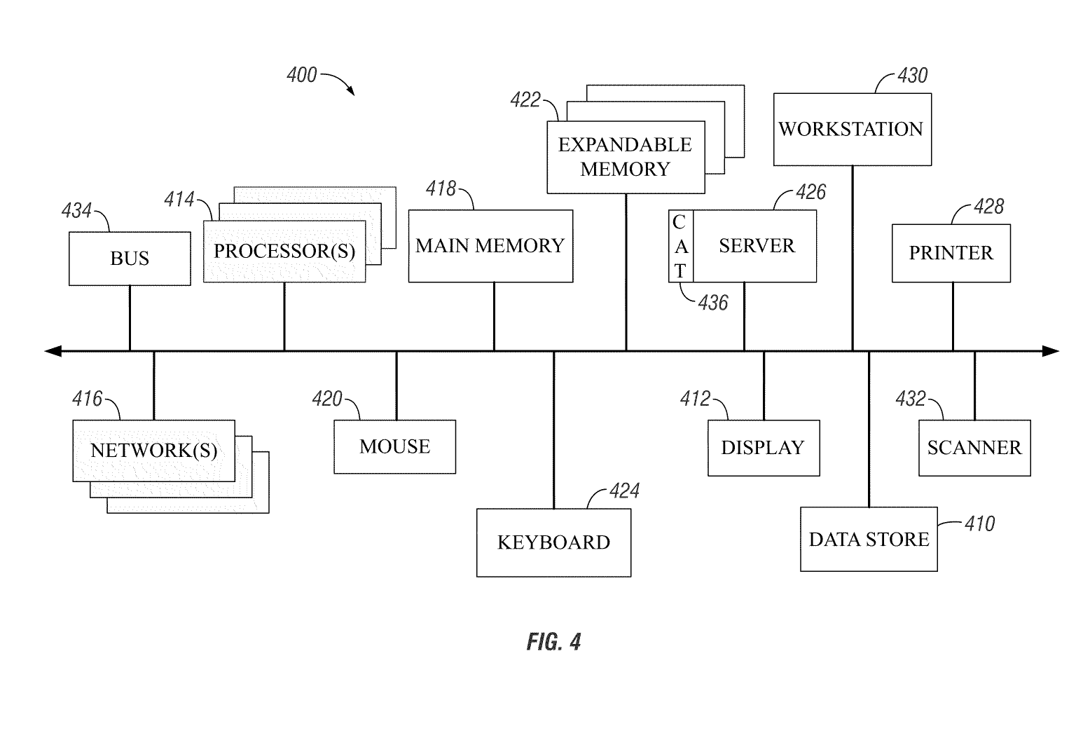

FIG. 4 is a block diagram of a computer network 400 in which an embodiment of the disclosure may be implemented. As shown in FIG. 4, the computer network 400 includes, for example, a server 426, workstation 430, scanner 432, a printer 428, a data store 410, and networks 416. The computer networks 416 are configured to provide a communication path for each device of the computer 240 shown in FIG. 1 to communicate with other devices. Additionally, the computer networks 416 can be the internet, a public switchable telephone network, a local area network, private wide area network, wireless network, and any of the like. In various embodiments of the disclosure, a CAT algorithm 436 can be executed on the server 426 and/or workstation 430. For example, in one embodiment of the disclosure, the server 426 can be configured to execute the CAT 436, provide outputs for display to the workstation 430, and receive inputs from the workstation 430. In various other embodiments, the workstation 430 can be configured to execute the CAT 436 individually or co-operatively with one or more other workstations. The scanner 432 can be configured to scan textual content and output the content in a computer readable format. The printer 428 can be configured to output the content to a print media, such as paper. Furthermore, data associated with adaptive test items, non-adaptive test items, interim score estimations, formulating adaptive/non-adaptive item ratio, examinee inputs/changes, test log(s), optimization process, constraints, and the like, can be stored on the datastore 410. The datastore 410 can additionally be configured to receive and/or forward some or all of the stored data. Moreover, in yet another embodiment, some or all of the computer network 400 can be subsumed within a single device.

Although FIG. 4 depicts a computer network, it is to be understood that the disclosure is not limited to operation within a computer network, but rather, the disclosure can be practiced in any suitable electronic device. Accordingly, the computer network depicted in FIG. 4 is for illustrative purposes only and thus is not meant to limit the disclosure in any respect.

FIG. 4 also illustrates a block diagram of the computer system 400 in which an embodiment of the disclosure can be implemented. As shown in FIG. 4, the computer system 400 includes a processor 414, a main memory 418, a mouse 420, a keyboard 424, and a bus 434. The bus 434 can be configured to provide a communication path for each element of the computer system 400 to communicate with other elements. The processors 414 can be configured to execute a software embodiment of the CAT 436. In this regard, a copy of computer executable code for the CAT 436 can be loaded in the main memory 418 for execution by the processor(s) 414. In addition to the computer executable code, the main memory can store data, including adaptive test items, non-adaptive test items, interim score estimations, formulating adaptive/non-adaptive item ratio, formulating test location/order of predefined test item positions, correlating item responses with correct answers at predefined test item positions, examinee inputs/changes, test log(s), optimization process, constraints, and the like. In operation, based on the computer executable code for an embodiment of the CAT 436, the processor(s) 414 can be received by a display adaptor (not shown) and converted into display commands configured to control the display 412. Furthermore, in a well-known manner, the mouse 420 and keyboard 424 can be utilized by a user to interface with the computer system 400, such as computer 240 shown in FIG. 1. The networks 416 can include a network adaptor (not shown) configured to provide two-way communication between the networks 416 and the computer system 400. In this regard, the CAT 436 and/or data associated with the CAT 436 can be stored on the networks 416 and accessed by the computer system 400, such as computer 240 shown in FIG. 1.

The present disclosure is not to be limited to the particular embodiments described herein. In particular, the present disclosure contemplates numerous variations in the type of ways in which embodiments of the disclosure can be applied to computer adaptive testing. The foregoing description has been presented for purposes of illustration and description. It is not intended to be an exhaustive list or limit any of the disclosure to the precise forms disclosed. It is contemplated that other alternatives or exemplary aspects that are considered are included in the disclosure. The description is merely examples of embodiments, processes or methods of the disclosure. For example, the methods for controlling the ratio between items matching an examinee's interim ability estimate and items that are independent of the test taker's ability can be varied according to use and test setting, test type, and other like parameters. In other examples, the systems and methods described herein can be altered to account for correct responses to test items at predefined test item positions, and varying test item counts and to adjust the order in which operations/steps are performed. It is understood that any other modifications, substitutions, and/or additions can be made, which are within the intended spirit and scope of the disclosure. For the foregoing, it can be seen that the disclosure accomplishes at least all of the intended objectives.

What is claimed is:

1. A method for controlling ability estimates in computer adaptive testing providing review and change of test item responses, the method comprising the steps of:
providing a pool of adaptive test items;
creating a pool of non-adaptive test items;
administering a computer adaptive test comprising:
a) selecting and administering one or more items from the pool of adaptive test items;
b) estimating interim ability after step (a);
c) selecting and administering at least one item from the pool of non-adaptive test items;
d) repeating step (a) and step (b) at least once; and
e) making subsequent selections of the one or more items from the pool of adaptive test items based on the interim ability estimate.

2. The method of claim 1 further comprising the step of:
maintaining a pre-defined ratio between the selected one or more items from the pool of adaptive test items and the selected at least one item from the pool of non-adaptive test items after each iteration of steps (a) through (c).

3. The method of claim 1 wherein the one or more items are randomly selected from pool of adaptive test items during a first iteration of steps (a) through (c).

4. The method of claim 1 further comprising the step of:
assembling the pool of non-adaptive test items prior to administering the computer adaptive test.

5. The method of claim 1 wherein the step of estimating interim ability occurs after each of step (a) and step (c).

6. The method of claim 1 further comprising the steps of:
determining whether a response to the selected adaptive test item is correct at predefined test item positions;
repeating step (a) and step (b) if the response is correct; and
repeating step (c) if the response is incorrect.

7. A system for controlling ability estimates in computer adaptive testing providing review and change of test item responses, comprising:
a pool of adaptive test items;
a pool of non-adaptive test items;
a computer adaptive test comprising:
a) one or more items selected from the pool of adaptive test items;
b) at least one item selected from the pool of non-adaptive test items administered subsequent to the one or more items from the pool of adaptive test items;
c) a first interim ability estimate subsequent to administration of the one or more items selected from the pool of adaptive test items;
d) a second interim ability estimate subsequent to administration of the at least one item selected from the pool of non-adaptive test items;
e) wherein at least one subsequent selection from the one or more items from the pool of adaptive test items is based on the first interim ability estimate or the second interim ability estimate.

8. The system of claim 7 further comprising:
a response correlator configured to determine whether a response to the one or more items selected from the pool of adaptive test items is correct; and
wherein the at least one item selected from the pool of non-adaptive test items is administered if the response is incorrect.

9. The system of claim 7 further comprising:
one or more opening test items administered prior to the one or more items selected from the pool of adaptive test items; and
wherein the one or more opening test items are randomly selected from the pool of adaptive test items.

10. The system of claim 7 wherein the list of non-adaptive test items is assembled prior administration of the computer adaptive test.

11. The system of claim 8 wherein the response correlator determines whether a response to the one or more items selected from the pool of adaptive test items is correct at predefined test item positions fewer than a total number of test items from the pool of adaptive test items.

12. The system of claim 7 further comprising:
a prescribed ratio between the one or more items selected from the pool of adaptive test items and the at least one item selected from the pool of non-adaptive test items.

13. The system of claim 7 further comprising:
one or more subsequent interim ability estimates taken from response to the at least one subsequent selection from the one or more items from the pool of adaptive test items that is based on the first interim ability estimate or the second interim ability estimate.

14. The system of claim 7 wherein administration of the at least one item selected from the pool of non-adaptive test items is unknown to a test taker.

15. A method for controlling ability estimates in computer adaptive testing providing review and change of test item responses, the method comprising the steps of:
generating a non-adaptive test item pool having a plurality of non-adaptive test items;
selecting an adaptive test item from an adaptive test item pool having a plurality of adaptive test items;
administering the selected adaptive test item from the pool of adaptive test items;
determining whether a response to the selected adaptive test item is correct;
if the response is correct:
(a) generating an interim ability estimate;
(b) selecting and administering another adaptive test item from the pool of adaptive test items based, at least in part, on the interim ability estimate;
if the response is incorrect, selecting and administering one of the plurality of non-adaptive test items from the non-adaptive test item pool.

16. The method of claim 15 further comprising the step of:
determining whether a response to the selected adaptive test item is correct at a predefined test item position, wherein the predefined test item position is unknown to a test taker.

17. The method of claim 16 wherein if a test item position is not the predefined test position, the method further comprises the steps of:
generating a subsequent interim ability estimate; and
selecting and administering yet another adaptive test item from the pool of adaptive test items based, at least in part, on the subsequent interim ability estimate.

18. The method of claim 15 further comprising the step of:
maintaining a prescribed ratio between administered adaptive test items and administered non-adaptive test items.

19. The method of claim 15 further comprising the steps of:
generating a subsequent interim ability estimate after a second response to the one of the plurality of non-adaptive test items; and
selecting and administering yet another adaptive test item from the pool of adaptive test items based, at least in part, on the subsequent interim ability estimate.

20. The method of claim 15 wherein the list of non-adaptive test items is assembled prior administration of the computer adaptive test.

21. A method for controlling ability estimates from review and change of test item responses in computer adaptive testing, comprising:
providing a computer adaptive test;
selecting one or more ability-dependent items;
selecting one or more ability-independent items, wherein the selected one or more ability-independent items are independent of a test taker's ability;
generating a plurality of interim estimates based on responses to the selected one or more ability-dependent items; and
wherein subsequent one or more ability-dependent items administered to the test taker are based on one of the plurality of interim estimates.

22. The method of claim 21 further comprising the step of:
maintaining a prescribed ratio between the ability-dependent items and ability-independent items to minimize overestimation of the test taker's ability scores after reviewing and changing one or more test items in the computer adaptive test.

23. The method of claim 21 wherein the one or more ability-independent items are selected only after an incorrect response is provided to the selected one or more ability-dependent items.

24. The method of claim 22 wherein the one or more ability-independent items are randomly dispersed throughout the computer adaptive test.

25. The method of claim 23 wherein the one or more ability-independent items are selected only after an incorrect response is provided to the selected one or more ability-dependent items at a predefined test item position.
